(19) United States
(12) Patent Application Publication
(10) Pub. No.: US 2026/0005265 A1
(43) Pub. Date: Jan. 1, 2026

(54) FLUID-CONDUCTING STRUCTURE FOR AN ELECTROCHEMICAL ENERGY CONVERTER AND ELECTROCHEMICAL ENERGY CONVERTER

(71) Applicant: Robert Bosch GmbH, Stuttgart (DE)

(72) Inventors: Eberhard Maier, Koengen (DE); Harald Schmeisser, Manubach (DE)

(21) Appl. No.: 18/878,303

(22) PCT Filed: Jun. 20, 2023
(86) PCT No.: PCT/EP2023/066582

§ 371 Date: Dec. 23, 2024

(30) Foreign Application Priority Data
Jun. 28, 2022 (DE) 10 2022 206 520.4

(51) Int. Cl. H01M 8/0258; H01M 8/0276

(52) U.S. Cl. CPC H01M 8/0258; H01M 8/0276

(57) ABSTRACT

The present invention relates to a fluid-conducting structure (50) for an electrochemical energy converter (11), having a separator plate (10) with a coolant passage opening (12, 13), a coolant passage bead (14, 15) at the coolant passage opening (12, 13), an active field (16) with a guide structure for guiding the coolant, an edge bead (17) which extends next to the active field (16) and next to the coolant passage bead (14, 15), a channel structure (41) between the coolant passage opening (12, 13) and the edge bead (17) for conducting a sealant (42) through the channel structure (41) into the edge bead (17), an inlet opening (43) for introducing the sealant (42) into the channel structure (41) in a stacking direction (39), and a deflection section (44) for deflecting the introduced sealant (42) from the stacking direction (39) into a transverse direction (40) as far as the edge bead (17). The invention further relates to an electrochemical energy converter (11) having a fluid-conducting structure (50) according to the invention.

### BACKGROUND

The present invention relates to a fluid-conducting structure for an electrochemical energy converter and an electrochemical energy converter, in particular in the form of a fuel cell stack, having a plurality of fluid-conducting structures.

In order to allow the electrochemical reactions in a fuel cell stack to take place evenly in an active field of a separator plate, in particular in the form of a bipolar plate, it is necessary to distribute the media flowing on the separator plate as evenly as possible. In addition, if possible, the entire coolant flow for the temperature control of the active field should be used. In known separator plates, however, a large proportion of the coolant flow can pass through an edge bead arranged around the active field as a bypass without the desired cooling effect. More specifically, the edge bead may be unintentionally fed through so-called vias, which are configured as feedthroughs for conducting the coolant from a coolant passage opening to the active field. Such separator plates can be found, for example, in the German utility model DE 20 2017 103229 U1. Various measures for reducing and/or preventing the bead bypass flow are proposed in DE 20 2017 103229 U1. Nevertheless, the system proposed in DE 20 2017 103229 U1 does not yet achieve satisfactory prevention of the bypass or a satisfactory channeling of the coolant. This results in a reduced cooling efficiency, a negative impact on the distribution of coolant in the active field, and consequently a reduction in the efficiency of the electrochemical system in which the separator plate is used. Increasing the coolant flow results in the supply and discharge ports having to handle a significantly higher media flow and thereby having a correspondingly higher pressure drop. The pressure drop then has a negative impact on the desired uniform distribution.

### SUMMARY

In the context of the present invention, a fluid-conducting structure and an electrochemical energy converter according to the disclosure are now proposed, which when used can achieve a more efficient and/or more effective use of the coolant compared to the prior art. In this context, features described in connection with the separator plate also apply in connection with the energy converter according to the invention, and vice versa, so that, with respect to the disclosure, mutual reference to the individual aspects of the invention is and/or can always be made.

According to a first aspect of the present invention, a fluid-conducting structure for an electrochemical energy converter having a separator plate is proposed. The separator plate comprises:
a first coolant passage opening and a second coolant passage opening for respectively conducting a coolant through the separator plate in a stacking direction,
a first coolant passage bead at the first coolant passage opening and a second coolant passage bead at the second coolant passage opening,
an active field with a guide structure at a front side of the active field for guiding the coolant at the front side in a transverse direction orthogonal to the stacking direction as well as a guide structure at a rear side of the active field for guiding a process fluid at the rear side in the transverse direction, and
an edge bead which extends next to the active field, next to the first coolant passage bead and next to the second coolant passage bead,

The fluid-conducting structure further comprises:
a channel structure between the first coolant passage opening and/or the second coolant passage opening and the edge bead for conducting a sealant through the channel structure into the edge bead,
an inlet opening for introducing the sealant into the channel structure in the stacking direction, and
a deflection section for deflecting the introduced sealant from the stacking direction into the transverse direction as far as the edge bead.

In the context of the invention, it was first recognized that introducing a sealant into the edge bead can easily and reliably prevent the bypass of the coolant described above. The proposed channel structure, and in particular the inlet opening for introducing the sealant in the stacking direction, makes it particularly easy to introduce the sealant at the desired location in the edge bead. In particular, a mechanical and/or automated introduction of the sealant into the channel structure can be easily and reliably realized by means of the fluid-conducting structure according to the invention.

The channel structure can comprise a plurality of spaced apart channel sections or blind vias. Preferably, the at least one blind via is tunnel-shaped and/or through-hole-shaped, but can also be channel-shaped. The blind via preferably extends obliquely or perpendicular to the respective bead. The inlet opening can be understood to mean at least one inlet opening, i.e. the fluid-conducting structure may have at least one inlet opening. Preferably, the fluid-conducting structure comprises a plurality of inlets, in particular two or four. Due to the configuration of the inlet openings according to the invention for introducing the sealant in the stacking direction, the inlet openings are easily contactable axially or in the stacking direction simultaneously via a simple interface. The channel structure can in particular be configured by two individual layers of the separator plate welded together.

The sealant can be understood to be a hardenable and/or foamable sealing fluid, which may be conducted through the channel structure to the desired location in the edge bead and harden there. A sealant hardened in the edge bead can be understood to be a blocking means for blocking a fluid flow through the edge bead. The sealant may comprise an elastomer or may be configured as an elastomer. This ensures that the blocking means resulting from the sealant does not change the deformation behavior of the beads and consequently has no shaping influence on the geometry of the base body of the separator plate described above.

The blocking means in the edge bead can effectively prevent the bypass flow that previously occurred or at least reduce it to an acceptable level. The proposed solution can easily be integrated into existing systems. Existing designs hardly need to be changed. This leads to low costs for the implementation of the solution according to the invention.

The separator plate can be understood to mean a bipolar plate, a monopolar plate, and/or a part of a bipolar plate. The electrochemical energy converter can be understood to mean a fuel cell, and in particular a fuel cell stack. The separator plate preferably comprises a one-piece and/or monolithic base body having the first coolant passage opening, the second coolant passage opening, the first coolant passage bead, the second coolant passage bead, the active field, and the edge bead. The terms front side and rear side were only chosen to differentiate between the different outer sides. Accordingly, the terms can be understood interchangeably.

The first coolant passage opening is preferably configured for introducing the coolant into the electrochemical system and the second coolant passage opening is preferably configured for conducting the coolant out of the electrochemical system. The coolant passage bead and the edge bead are at least partially separated from each other by a web, for example an edge bead web.

The channel structure is preferably configured for conducting the sealant into the edge bead next to the respective coolant passage bead. This can be understood to mean that the sealant can be conducted into a section of the edge bead that extends next to and/or along the respective coolant passage bead, in particular next to it. The blocking means produced by the sealant may extend within or at least substantially within the edge bead, preferably in a linearly curved manner next to the respective coolant passage bead. Accordingly, the sealant can be introduced into a part of the groove or recess formed by the edge bead by means of the channel structure.

The first coolant passage bead and the second coolant passage bead each preferably extend completely around the respective coolant passage opening. Preferably, the edge bead extends continuously along a part of the coolant passage beads and along an outer edge of the active field. The coolant passage beads are preferably configured outside of a ring or a closed loop formed by the edge bead. The process fluid can be understood to mean hydrogen, a hydrogen-containing fluid, oxygen, and/or an oxygen-containing fluid, particularly air.

Furthermore, it is possible that a separator plate according to the invention comprises
a first hydrogen passage opening for conducting hydrogen through the separator plate and a first hydrogen passage bead at the first hydrogen passage opening,
a first oxygen passage opening for conducting oxygen through the separator plate and a first oxygen passage bead at the first oxygen passage opening,
a second hydrogen passage opening for conducting hydrogen through the separator plate and a second hydrogen passage bead at the second hydrogen passage opening, and
a second oxygen passage opening for conducting oxygen through the separator plate and a second oxygen passage bead at the second oxygen passage opening,
wherein the channel structure is configured to conduct the sealant into a part of the edge bead in which the edge bead extends between the first coolant passage bead and the first hydrogen passage bead, between the first coolant passage bead and the first oxygen passage bead, between the second coolant passage bead and the second hydrogen passage bead, and/or extend between the second coolant passage bead and the second oxygen passage bead. At these positions, an effective blocking effect or the desired sealing effect can be achieved with low cost and material expenditure.

It has also proved to be particularly advantageous if the channel structure in a separator plate is configured in such a way that the sealant can be conducted
into a part of the edge bead in which the edge bead extends between the first coolant passage bead and the first hydrogen passage bead,
into a part of the edge bead in which the edge bead extends between the first coolant passage bead and the first oxygen passage bead,
into a part of the edge bead in which the edge bead extends between the second coolant passage bead and the second hydrogen passage bead, and
into a part of the edge bead in which the edge bead extends between the second coolant passage bead and the second oxygen passage bead.

This allows a blocking means to be generated at a location where it can generate a particularly effective sealing effect for preventing a bypass flow, so that the coolant can be conducted into the active field with as little loss as possible, as desired.

As an alternative to the design variant described above, the channel structure can be configured in such a way that the sealant can only be conducted
into a part of the edge bead in which the edge bead extends between the first coolant passage bead and the first hydrogen passage bead, and
into a part of the edge bead in which the edge bead extends between the second coolant passage bead and the second hydrogen passage bead.

Furthermore, it is possible that the channel structure is configured in a separator plate according to the invention in order to conduct the sealant only
into a part of the edge bead in which the edge bead extends between the first coolant passage bead and the first hydrogen passage bead, and
into a part of the edge bead in which the edge bead extends between the first coolant passage bead and the first oxygen passage bead.

In addition, the channel structure may be configured such that the sealant may be conducted into the first coolant passage bead next to the edge bead and/or into the second coolant passage bead next to the edge bead, such that at least one further blocking means may be formed there for blocking a fluid flow through the first coolant passage bead and/or through the second coolant passage bead. The at least one further blocking means may extend within the respective coolant passage bead in a linear and/or curved manner according to the blocking means described above following the respective coolant passage web. The blocking and/or sealing effect can be easily and cost-effectively reinforced by the at least one additionally designed blocking means.

According to a further embodiment of the present invention, it is possible that the inlet opening may be funnel-shaped. The sealant can thus be conveyed reliably into the channel structure in a simple manner. Highly precise automation regarding the introduction of the sealant into the channel structure can be dispensed with.

Furthermore, it is possible that the channel structure of a fluid-conducting structure according to the invention is formed by two sheet structures welded together, wherein at least one weld seam is configured for the material-locking connection of the two sheet structures, partially surrounding and/or partially ring-shaped around the one inlet opening. The weld seam or the corresponding weld can reliably prevent the intrusion of sealing material into the port area or the coolant opening in a straightforward manner. Furthermore, individual layers of the separator plate may be prevented from being pushed apart upon possible foaming of the sealant.

In addition, it is possible that the channel structure of a fluid structure according to the present invention is formed by two welded sheet structures, wherein at least one weld seam is configured to connect the two sheet structures to each other in a material-locking manner, between the first coolant passage opening and the first coolant passage bead and/or between the second coolant passage opening and the second coolant passage bead. Such a weld seam or a corresponding welding process can easily and reliably prevent an intrusion of sealant in the direction of the active area and/or the distributor area of the separator plate. This means that the weld seam may be configured not only in the area around the inlet opening but also along the coolant passage beads. This weld seam may be configured as a separate weld seam or as part of an overall weld seam that comprises the weld seam extending around the inlet opening described above. The weld seam or weld may extend partially along the respective coolant passage bead.

According to a further embodiment of the present invention, it is possible that the inlet opening in and/or at the first coolant passage opening and/or the second coolant passage opening is configured in a fluid-conducting structure. In this area, the inlet opening may be configured without or at least without a substantial influence on the sealing function of the separator plate, retrofitted and/or adapted to existing separator plate designs.

Furthermore, it is possible that in a fluid-conducting structure according to the invention, the channel structure is configured as an integral and/or monolithic component of the first coolant passage bead, the second coolant bead and/or the edge bead. The channel structure can thus be realized in a particularly space-saving manner. The channel structure may in particular be configured as part of the embossing pattern of the separator plate.

In a fluid-conducting structure according to the present invention, it is further possible that an inlet structure comprising the inlet opening and the deflection section is configured as an integral and/or monolithic component of the separator plate. This means that the inlet opening or a structural component including the inlet opening and the deflection section may be provided as an integral and/or monolithic component of the separator plate and/or the two individual layers of the separator plate. Alternatively or additionally, it is possible for the inlet structure in a fluid-conducting structure according to the invention to be configured to be non-destructively releasable from the separator plate or to be separated from the separator plate after the sealant has been introduced. This means that the inlet structure may, in addition to or alternatively to integrated inlet structures, be provided as an adapter component that is attached to and/or positioned on the separator plate in order to introduce the sealant at the desired location in and/or on the separator plate, and can then be removed again. This has the particular advantage that the inlet structures may be removed from the coolant passage openings for operation of the electrochemical energy converter.

Furthermore, in a fluid-conducting structure according to the present invention, the channel structure can be configured for conducting the sealant through the channel structure into the first coolant passage bead and/or into the second coolant passage bead. This means that the channel structure can be used to introduce the sealant not only into the edge bead, but also into the respective coolant passage bead. The channel structure thus provides a space-saving and reliably functioning means for easily producing a blocking means in the first coolant passage bead and/or in the second coolant passage bead.

According to a further aspect of the present invention, an electrochemical energy converter having a plurality of fluid-conducting structures as described above is proposed. The energy converter according to the invention thus has the same advantages as those described in detail with reference to the fluid-conducting structure according to the invention. The electrochemical energy converter can be understood to mean a fuel cell or a fuel cell stack.

Further measures that improve the invention are shown in the following description of various exemplary embodiments of the invention, which are shown schematically in the figures.

All features and/or advantages resulting from the claims, the description, or the figures, including design details and spatial arrangements, can be essential to the invention both individually and in the various combinations.

### BRIEF DESCRIPTION OF THE DRAWINGS

Schematically shown are:

FIG. 1 a fluid-conducting structure according to a first embodiment of the present invention,

FIG. 2 a channel structure for a fluid-conducting structure according to a second embodiment of the present invention,

FIG. 3 a fluid-conducting structure according to a third embodiment of the present invention, and

FIG. 4 an electrochemical energy converter with a separator plate according to the invention.

### DETAILED DESCRIPTION

Elements having the same function and mode of action are in each case provided with the same reference signs in the figures.

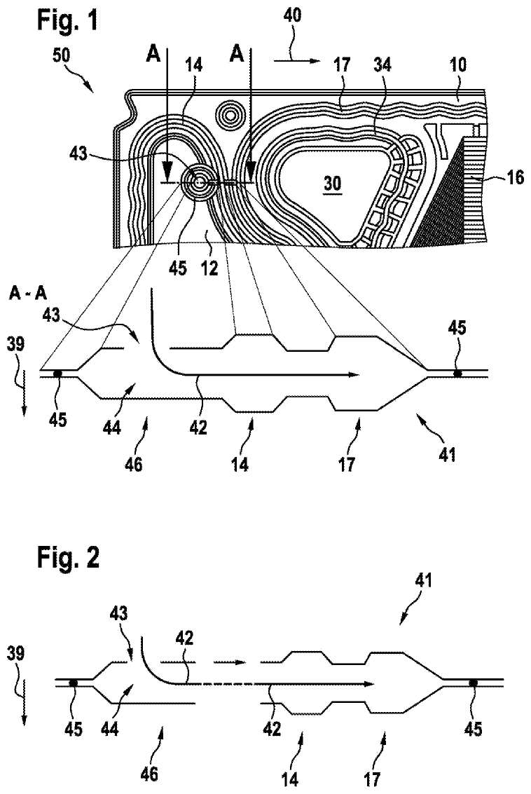

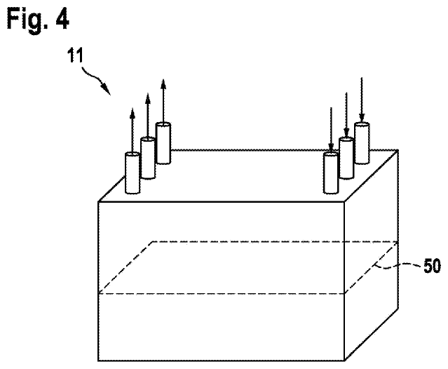

In FIG. 1, a fluid-conducting structure 50 for an electrochemical energy converter 11 shown in FIG. 4 is shown according to a first embodiment. The fluid-conducting structure 50 includes a separator plate 10 having a first coolant passage opening 12 for conducting a coolant through the separator plate 10 in a stacking direction 39. The separator plate 10 further comprises a first coolant passage bead 14 at the first coolant passage opening 12 and an active field 16 with a guide structure at a front side of the active field 16 for guiding the coolant at the front side in a transverse direction 40 orthogonal to the stacking direction 39 and a guide structure at a rear side of the active field 16 for guiding a process fluid at the rear side in the transverse direction 40. In addition, the separator plate 10 has an edge bead 17 that extends next to the active field 16 and next to the first coolant passage bead 14 or partially along it. The fluid-conducting structure 50 has a channel structure 41 between the first coolant passage opening 12 and the edge bead 17 for conducting a sealant 42 through the channel structure 41 in the edge bead 17. For this purpose, the fluid-conducting structure 50 further comprises an inlet opening 43 for introducing the sealant 42 into the channel structure 41 in the stacking direction 39 and a deflection section 44 for deflecting the introduced sealant 42 from the stacking direction 39 in the transverse direction 40 towards the edge bead 17. As can be seen in FIG. 1, the channel structure 41 is formed by two welded sheet structures, wherein a weld seam 45 is configured for the material-locking connection of the two sheet structures, partially ring-shaped or partially surrounding the one inlet opening 43. The weld seam is also configured along a part of the first coolant passage bead 14. A further weld seam 45 is configured along the edge bead 17. The inlet opening 43 and the deflection section 44 are configured as part of an inlet structure 46, wherein the inlet structure 46 is configured as an integral part of the separator plate 10. The inlet structure 46 is configured within the first coolant passage opening 12. The channel structure 41 is configured as an integral part of the first coolant passage bead 14 and the edge bead 17. The channel structure 41 is further configured for conducting the sealant 42 into the first coolant passage bead 14.

FIG. 2 shows a channel structure 41 for a fluid-conducting structure 50 according to a second embodiment. According to this embodiment, the inlet structure 46, which comprises the inlet opening 43 and the deflection section 44, is configured as an adapter component that can be positioned for introducing the sealant 42 into a part of the channel structure 41 in the direction of the edge bead 17 at a channel opening within the first coolant passage opening 12 of the separator plate 10 and can subsequently be non-destructively released.

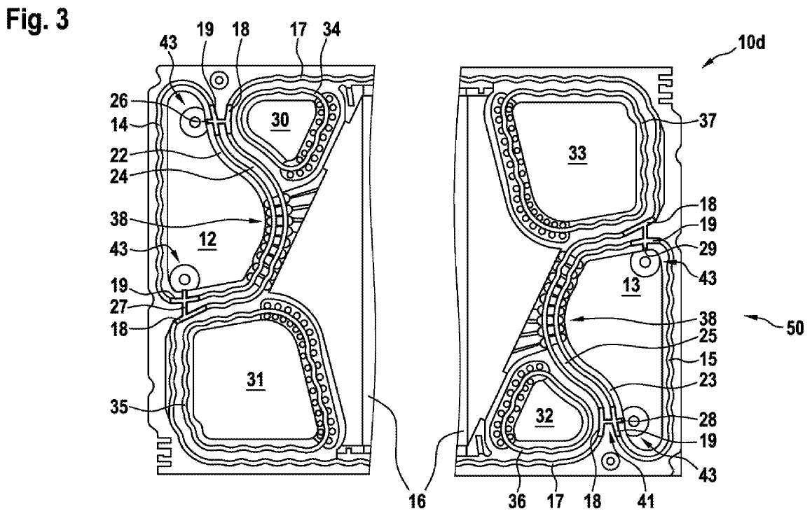

FIG. 3 shows a fluid-conducting structure 50 having a separator plate 10 according to another embodiment. The separator plate 10 shown comprises a first coolant passage opening 12 and a second coolant passage opening 13 for respectively conducting a coolant through the separator plate 10. Furthermore, the separator plate 10 comprises a first coolant passage bead 14 at the first coolant passage opening 12, a second coolant passage bead 15 at the second coolant passage opening 13 and an active field 16 having a guide structure at a front side of the active field for guiding the coolant at the front side, and a guide structure at a rear side of the active field 16 for guiding a process fluid at the rear side. In addition, the separator plate comprises an edge bead 17 which extends continuously next to the active field 16, next to the first coolant passage bead 14, and next to the second coolant passage bead 15. In the edge bead 17 next to the first coolant passage bead 14 and next to the second coolant passage bead 15, two blocking means 18 are configured in each case for blocking a fluid flow through the edge bead 17 at these points. The blocking means 18 was configured by introducing the sealant 42 into the channel structure 41 shown in FIG. 1 and then hardening the sealant 42. In the separator plate 10 shown in FIG. 3, two further blocking means 19 are formed in the first coolant passage bead 14 next to the edge bead 17 and in the second coolant passage bead 15 next to the edge bead 17 for blocking a fluid flow through the first coolant passage bead 14 and through the second coolant passage bead 15 at this point. To produce the blocking means 19, a channel structure 41 with four blind vias 26, 27, 28, 29 is configured in the separator plate 10, wherein the channel structure 41 or the blind vias 26, 27, 28, 29 are also configured in each case for conducting the sealant 42 into the first passage bead 14 and into the second coolant passage bead 15 in order to produce the corresponding blocking means 18, 19 there.

As shown in FIG. 3, the separator plate 10 further comprises a first hydrogen passage opening 30 for conducting hydrogen or a hydrogen containing fluid through the separator plate 10 and a first hydrogen passage bead 34 around the first hydrogen passage opening 30, a first oxygen passage opening 31 for conducting oxygen or an oxygen-containing fluid, in particular air, through the separator plate 10 and a first oxygen passage bead 35 around the first oxygen passage opening 31, a second hydrogen passage opening 32 for conducting hydrogen through the separator plate 10 and a second hydrogen passage bead 36 around the second hydrogen passage opening 32, a second oxygen passage opening 33 for conducting oxygen through the separator plate 10 and a second oxygen passage bead 37 around the second oxygen passage opening 33.

The embodiment shown in FIG. 3 further comprises a first coolant passage web 22, which is configured between the first coolant passage opening 12 and the first coolant passage bead 14, a second coolant passage web 23, which is configured between the second coolant passage opening 13 and the second coolant passage bead 15, a first edge bead web 24, which is configured between the first coolant bead 14 and the edge bead 17 and a second edge bead web 25, which is configured between the second coolant bead 15 and the edge bead 17. The separator plate 10 shown further comprises conventional vias 38 for conducting the coolant towards the active field 16.

FIG. 4 shows an electrochemical energy converter 11 in the form of a fuel cell stack, in which a separator plate 10 is symbolically shown. Of course, in the actual fuel cell stack, a plurality of separator plates 10 are arranged in a generic manner.

The invention allows for further design principles in addition to the illustrated embodiments. That is to say, the invention is not intended to be limited to the exemplary embodiments explained with reference to the figures.

1. A fluid-conducting structure (50) for an electrochemical energy converter (11), having a separator plate (10) with
a first coolant passage opening (12) and a second coolant passage opening (13) for respectively conducting a coolant through the separator plate (10) in a stacking direction (39),
a first coolant passage bead (14) at the first coolant passage opening (12) and a second coolant passage bead (15) at the second coolant passage opening (13),
an active field (16) with a guide structure at a front side of the active field (16) for guiding the coolant at the front side in a transverse direction (40) orthogonal to the stacking direction (39) as well as a guide structure at a rear side of the active field (16) for guiding a process fluid at the rear side in the transverse direction (40), and
an edge bead (17) which extends next to the active field (16), next to the first coolant passage bead (14) and next to the second coolant passage bead (15),
wherein
a channel structure (41) between the first coolant passage opening (12) and/or the second coolant passage opening (13) and the edge bead (17) for conducting a sealant (42) through the channel structure (41) into the edge bead (17),
an inlet opening (43) for introducing the sealant (42) into the channel structure (41) in the stacking direction (39), and
a deflection section (44) for deflecting the introduced sealant (42) from the stacking direction (39) into the transverse direction (40) as far as the edge bead (17).

2. The fluid-conducting structure (50) according to claim 1,
wherein
the inlet opening (43) is funnel shaped.

3. The fluid-conducting structure (50) according to claim 1,
wherein
the channel structure (41) is formed by two welded sheet structures, wherein at least one weld seam (45) is configured for a material-locking connection of the two sheet structures, partially surrounding the inlet opening (43).

4. The fluid-conducting structure (50) according to claim 1,
wherein
the channel structure (41) is formed by two welded sheet structures, wherein at least one weld seam (45) is configured to connect the two sheet structures in a material-locking manner, between the first coolant passage opening (12) and the first coolant passage bead (14) and/or between the second coolant passage opening (13) and the second coolant passage bead (15).

5. The fluid-conducting structure (50) according to claim 1,
wherein
the inlet opening (43) is configured in and/or at the first coolant passage opening (12) and/or the second coolant passage opening (13).

6. The fluid-conducting structure (50) according to claim 1,
wherein
the channel structure (41) is configured as an integral and/or monolithic component of the first coolant passage bead (14), the second coolant passage bead (15), and/or the edge bead (17).

7. The fluid-conducting structure (50) according to claim 1,
wherein
an inlet structure (46) comprises the inlet opening (43) and the deflection section (44), wherein the inlet structure (46) is configured as an integral and/or monolithic component of the separator plate (10).

8. The fluid-conducting structure (50) according to claim 1,
wherein
an inlet structure (46) comprises the inlet opening (43) and the deflection section (44), wherein the inlet structure (46) is configured to be non-destructively releasable from the separator plate (10).

9. The fluid-conducting structure (50) according to claim 1,
wherein
the channel structure (41) is configured for conducting the sealant (42) through the channel structure (41) into the first coolant passage bead (14) and/or into the second coolant passage bead (15).

10. An electrochemical energy converter (11) having a plurality of fluid-conducting structures (50) according to claim 1.
